(19) United States
(12) Patent Application Publication
(10) Pub. No.: US 2021/0321597 A1
(43) Pub. Date: Oct. 21, 2021

(54) Aautomatic fishing rod lifter that prevents unintentional injury

(71) Applicant: Caigao LUO, GUANGDONG (CN)

(72) Inventor: Caigao LUO, GUANGDONG (CN)

(21) Appl. No.: 17/230,977

(22) Filed: Apr. 14, 2021

(30) Foreign Application Priority Data
Apr. 16, 2020 (CN) 202020568816.5

(51) Int. Cl. A01K 97/10; F16M 11/20

(52) U.S. Cl. CPC A01K 97/10; F16M 11/2021

(57) ABSTRACT

An automatic fishing rod lifter, including an upper arm, a lower arm, and at least one tension spring connecting the two; the upper arm and the lower arm are movably connected so that they are capable of folding and unfolding with respect to each other; a self-lock trigger mechanism is provided at the upper arm and the lower arm; also provided is a protective cover positioned above the tension spring; one end of the protective cover is movably connected with the lower arm, so that the protective cover can use said one end of the protective cover as a pivot point to flip. The protective cover increases safety of operation and thus reduces the risk of injury due to careless maneuver or insufficient folding strength applied to the upper arm and the lower arm. The automatic fishing rod lifter is suitable to be used by both newbies and veterans.

### BACKGROUND OF THE INVENTION

The present invention relates to a kind of fishing tool, and more specifically relates to an automatic fishing rod lifter that may prevent users from unintentional injury during operation of the same.

Automatic fishing rod lifter is a kind of device that can automatically lift up a fishing rod by making use of a folding mechanism and a self-lock trigger mechanism. The use of automatic fishing rod lifter facilitates a single user to use multiple fishing rods at the same time so that user can free his hands and thereby increasing the joy and efficiency of fishing, while at the same time more fish can be caught. However, if this kind of automatic fishing rod lifter is not used properly or being carelessly maneuvered, user's hands may easily be injured, especially for newbies, who expose themselves to a much higher risk of injury.

CN208144255U, also invented by the same inventor of the present application, discloses a kind of automatic fishing rod lifter, comprising a structural arm, a rod supporting arm, and a tension spring connecting the structural arm and the rod supporting arm; the supporting arm is provided with a self-lock trigger mechanism; the rod supporting arm is provided with buckle rod body cooperating with the self-lock trigger mechanism; the self-lock trigger mechanism comprises a lock plate and a trigger; the lock plate and the trigger are positioned on a side surface of the structural arm; one end of the lock plate is movably connected with the structural arm, and another end of which is formed as an abutting concave arc; also, a side edge of the lock plate facing outwardly is provided with a notch adapted to be buckled by the buckling rod body; a head portion of the trigger is movably connected with the structural arm; and a periphery of the head portion of the trigger is formed as an arc surface that provide abutting resistance against the abutting concave arc. When using such a given automatic fishing rod lifter, one hand of the user holds the structural arm, and another hand of the user holds the rod supporting arm; as the structural arm and the rod supporting arm are mutually rotatable at a pivot joint, the user may rotate the rod supporting arm with respect to the structural arm about the pivot joint by pressing both the structural arm and the rod supporting arm downwardly, until the buckling rod body buckles into the notch of the lock plate. During this process, there is a gap existing between the structural arm, the rod supporting arm and the tension spring. Due to improper operation or when the pressing force against the structural arm and the rod supporting arm is not great enough, and if user's fingers are placed in the gap or on the tension spring during operation, rebounding force of the structural arm will injure the user or the user's fingers may be injured by the tension spring. These accidents are particularly common among newbies.

### BRIEF SUMMARY OF THE INVENTION

In view of the aforesaid disadvantages of unintentional injury of users easily caused by the aforesaid described automatic fishing rod lifter, the present invention provides an automatic fishing rod lifter that prevents unintentional injury and increases the safety of use.

To obtain the above objects of the present invention, the present invention comprises: an upper arm, a lower arm, a protective cover, and at least one tension spring connecting the upper arm and the lower arm; the upper arm and the lower arm are movably connected so that the upper arm and the lower arm are capable of folding and unfolding with respect to each other; a self-lock trigger mechanism is provided at the upper arm and the lower arm; the protective cover is positioned above the tension spring; one end of the protective cover is movably connected with the lower arm, so that the protective cover is capable of using said one end of the protective cover as a pivot point to flip. In the present invention, the protective cover providing protective effect is provided such that the protective cover covers the tension spring during the process of folding the upper arm and the lower arm against each other, and as such, users are prevented from injury due to the clamping force or rebounding force of the tension spring in case of careless maneuver of the automatic fishing rod lifter or insufficient folding strength applied to the upper arm and lower arm. Also, the protective cover prevents newbies from unintentionally placing their fingers at the tension springs.

Preferably, the lower arm is provided with a first connecting rod; also, two sides of said one end of the protective cover that allows the protective cover to flip with respective to the lower arm are symmetrically provided with axle holes respectively; the axle holes of the protective cover are engaged by two ends of the first connecting rod respectively; the axle holes are also provided with openings. In the present invention, the protective cover is connected to the first connecting rod via the axle holes, such that the protective cover can make use of said one end of the protective cover as a pivot point to flip; also, the openings on the axle holes of the protective cover are provided such that the first connecting rod can pass through the openings and engages into the axle holes, thereby facilitating mounting and dismounting.

Preferably, the automatic fishing rod lifter also comprises a ground mount; one end of the ground mount is movably connected with an inner end of the lower arm, so that the ground mount is foldable; also, an upper side of the protective cover is provided with a recess that correspond to a shape of the ground mount and into which the ground mount can be embedded. In the present invention, the ground mount is stored and deployed by being folded and unfolded respectively; also, due to the corresponding recess on the protective cover, the automatic fishing rod lifter can be further reduced in size, thereby facilitating package transportation and hand carrying.

Preferably, said one end of the ground mount is provided with position limiting slots; also, the inner end of the lower arm is provided with a second connecting rod; the second connecting rod slides and engages into the position limiting slots. In the present invention, these configurations prevent folding of the ground mount by external forces after it is deployed, which may otherwise affect stability of the present invention mounted into the ground and the precision of the fishing rod lifting operation. The second connecting rod slides into and engages with the positing limiting slots so as to lock the deployed position of the ground mount, preventing its random folding, and thus facilitating easy and convenient operation.

Compared with the existing prior arts, the present invention has additionally provided a protective cover to increase safety during operation of the automatic fishing rod lifter, thereby significantly reducing the risk of user's injury due to careless maneuver of the present invention or insufficient folding strength applied to the upper arm and the lower arm. The present invention is suitable to be used by both newbies and veterans.

### BRIEF DESCRIPTION OF THE DRAWINGS

FIG. 1 is a structural view of the present invention according to a first embodiment.

FIG. 2 is a structural view of the protective cover according to the first embodiment of the present invention.

FIG. 3 is a structural view of the present invention according to a second embodiment.

FIG. 4 is a structural view of the protective cover according to the second embodiment of the present invention.

FIG. 5 is a structural view of a spring adjuster according to the present invention.

References in the figures: 1—upper arm; 3—lower arm; 4—ground mount; 5—protective cover; 6—tension springs; 7—strap; 8—spring adjuster; 20—buckling rod; 21—pin; 22—notch; 23—lock plate; 24—trigger; 31—first connecting rod; 32—second connecting rod; 41—position limiting slots; 51—axle holes; 52—openings; 53—recess; 54—trough; 55—position limiting holes; 56—indentation; 57—position limiting protrusions; 81—handle; 82—hook; 83—flexible gap; A—first connecting seat; B—second connecting seat; C—third connecting seat; D—fourth connecting seat.

### DETAILED DESCRIPTION OF THE INVENTION

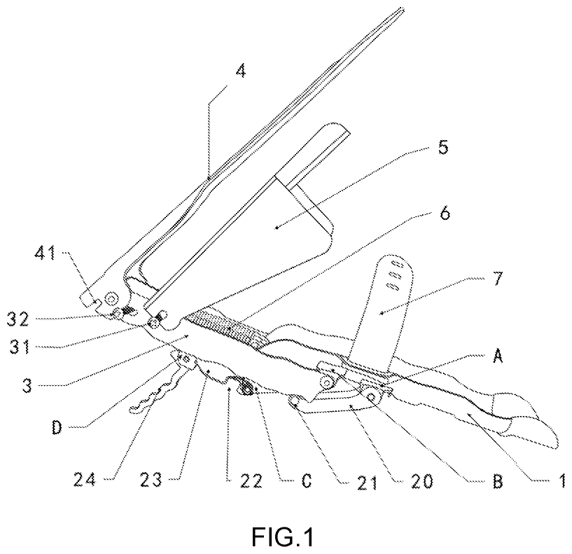

With reference of FIG. 1, the present invention mainly comprises an upper arm 1, a lower arm 3, a tension springs 6, a self-lock trigger mechanism, a protective cover 5, and a ground mount 4. Except of the protective cover, other components are casted in shape by using iron or stainless steel.

The upper arm 1 serves to support a fishing rod, and has a U-shape profile; a concave surface of the U-shape profile (i.e. an upper side of the upper arm) allows a handle part of the fishing rod to be placed within; a strap 7 is provided over the concave surface of the U-shape profile and traverses over the concave surface of the U-shape profile; one end of the strap 7 is connected at an outer side of the concave surface, and another end of the strap 7 is buckled at a corresponding opposite outer side of the concave surface via a buckle slot; the strap 7 reinforces position fixing of the fishing rod; a convex surface of the U-shape profile (i.e. a lower side of the upper arm) is provided with a first connecting seat A and a second connecting seat B.

The lower arm 3 serves to support the upper arm 1, and has a “␣”-shape profile; an outer end of the “␣”-shape profile is movably connected with the second connecting seat B via a rivet, such that the upper arm 1 and the lower arm 3 can be movably connected by being mutually folded or unfolded; an inner end of the “␣”-shape profile is provided with a first connecting rod 31 and a second connecting rod 32; the first connecting rod 31 and the second connecting rod 32 are both screws. During connection, the first connecting rod 31 passes through the lower arm 3 so that a body of the first connecting rod 31 is positioned within a groove of the “␣”-shape profile while two ends of the first connecting rod are positioned at two outer sides of the “␣”-shape profile respectively; a nut is provided to prevent the first connecting rod 31 from falling off; the second connecting rod 32 passes through the lower arm 3 and is slidable back and forth; a body of the second connecting rod 32 is positioned within the groove of the “␣”-shape profile while two ends of the second connecting rod are positioned at the two outer sides of the “␣”-shape profile respectively; another nut is also provided to prevent the second connecting rod 32 from falling off; a lower portion of the “␣”-shape profile is provided with a third connecting seat C and a fourth connecting seat D.

Two tension springs 6 are provided, and both are positioned within the groove of the lower arm 3; one ends of the tension springs 6 hook on to an inner end of the upper arm 1; another ends of the tension springs 6 hook onto the body of the first connecting rod 31, so that there is a strong tensional force between the upper arm 1 and the lower arm 3, enabling the upper arm 1 and the lower arm 3 to be tensioned against each other.

The self-lock trigger mechanism mainly comprises a buckling rod 20, a lock plate 23 and a trigger 24; the buckling rod 20 is provided at a lower portion of the upper arm 1; one end of the buckling rod 20 is movably riveted with the first connecting seat A via a rivet and a torsion spring, so that the buckling rod 20 can make use of said one end of the same as a pivot point about which the buckling rod 20 can flip and reset; another end of the buckling rod 20 is provided with a pin 21; the lock plate 23 is provided at the lower portion of the lower arm 3; one end of the lock plate 23 is movably connected with the third connecting seat C via a bolt, a nut and a torsion spring, so that the lock plate 23 can make us of said one end of the same as a pivot point about which the lock plate 23 can flip and reset; another end of the lock plate 23 is provided with an abutting concave arc; an outward facing side of the lock plate 23 is provided with a notch 22, so that when the upper arm 1 is rotated (folded) to a certain degree, the pin 21 of the bucking rod 20 will buckle into the notch 22 and held by the notch 22 the trigger 24 is positioned adjacent to the lock plate 23; a head portion of the trigger 24 is movably riveted with the fourth connecting seat D, so that the trigger can make use of the head portion of the same as a pivot point about which the trigger 24 can flip; a peripheral portion of the head portion of the trigger 24 is provided with an arc surface which provides abutting resistance against the abutting concave arc; when the pin 21 of the buckling rod 20 buckles into the notch 22 of the lock plate 23 the arc surface of the trigger 24 provides abutting force against the abutting concave arc of the lock plate 23 to lock the position of the lock plate 23 so that the lock plate 23 is unmovable. When activating the trigger 24, the abutting force between the arc surface of the trigger 24 and the abutting concave arc of the lock plate 23 will disappear, and due to the effect of the torsion spring of the lock plate 23, the lock plate 23 will flip outwardly, and as such, the pin of the buckling rod 20 will be disengaged from the notch of the lock plate 23, and therefore, the upper arm 1 will be quickly pulled straight due to the tensional force provided by the tension springs 6.

The self-lock trigger mechanism described above is configured according to the same structural principle as described in CN208144255U. Alternatively, the self-lock trigger mechanism of the present invention can also be replaced by other known self-lock trigger mechanisms that achieve the same technical effects.

One end of the ground mount 4 is movably riveted with the lower arm 3, so that ground mount 4 can be folded towards the groove of the lower arm 3; two sides of said one end of the ground mount 4 are provided with position limiting slots 41 respectively; the position limiting slots 41 allows the second connecting rod 32 to be movably placed inside to lock a deployed position of the ground mount 4; another end of the ground mount 4 has a conical shape to facilitate mounting into the ground.

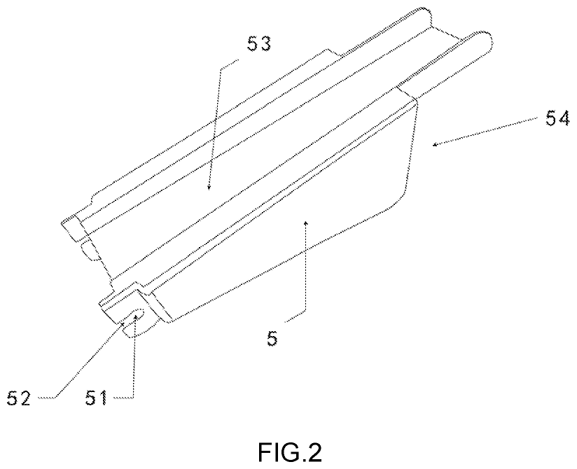

With reference to FIG. 1 and FIG. 2, the protective cover 5 is positioned above the tension springs 6; a lower side of the protective cover 5 is formed as a trough 54 that covers a connecting zone of the tension springs 6, the upper arm 1 and the lower arm 3; two sides of one end of the protective cover 5 are symmetrically provided with a pair of axle holes 51 respectively; axle holes 51 are provided with openings 52 through which the protective cover 5 is engaged with the two ends of the first connecting rod 31; therefore the protective cover 5 can flip by making use of the first connecting rod 31 as an axis; also, the openings 52 of the axle holes 51 facilitates mounting and dismounting of the protective cover 5 with the first connecting rod 31; alternatively, the axle holes 51 may be configured as completely closed holes without any opening for the purpose of connection with the first connecting rod; an upper side of the protective cover 5 is also provided with a recess 53 having a shape corresponding to a shape of the ground mount 4 so that the ground mount 4 may be folded and stored within the recess 53.

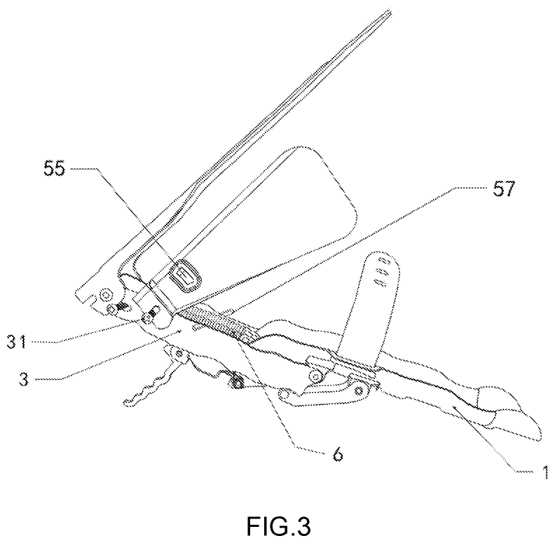

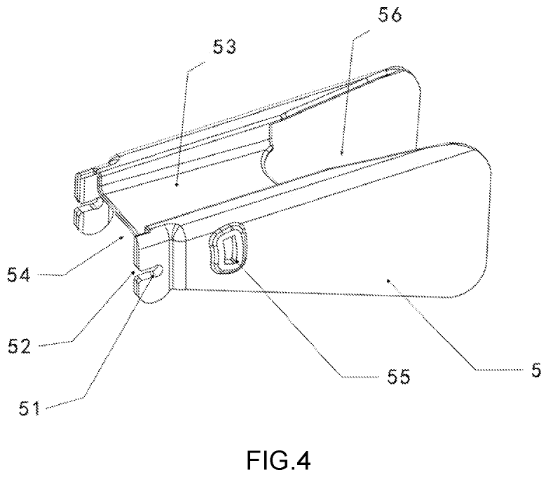

With reference to FIG. 3 and FIG. 4, according to a second embodiment of the present invention, outwardly extending position limiting protrusions 57 are provided at two corresponding opposite positions of two sides of the lower arm 3 respectively; correspondingly, the protective cover 5 that covers the tension springs 6 is provided at two sides thereof with elongated position limiting holes 55 respectively; the position limiting holes 55 correspond to the position limiting protrusions 57 of the lower arm 3 respectively, and the position limiting protrusions 57 are engaged into and slidable within the position limiting holes 55 respectively, so that mutual sliding movement and limitation of said sliding movement are achieved between the position limiting protrusions 57 and the position limiting holes 55. When the protective cover 5 flips, its flipping angle and magnitude are being limited, such that when the automatic fishing rod lifter operates to lift up (reset the position of) the fishing rod, the protective cover 5 can be prevented from being mechanically displaced which otherwise results in its failure to automatically restore its position to cover the tension springs 6 again, or the protective cover 5 can be prevented from being completed disengaged from the automatic fishing rod lifter as a result of mechanical displacement. In either case where the protective cover 5 is mechanically displaced leading to its failure to automatically restore its position or the protective cover 5 is completely disengaged from the automatic fishing rod lifter, the protective cover 5 may only be restored back to its original position manually.

In the second embodiment, an end surface of a front end of the protective cover 5 is also provided with a U-shape indentation 56 to evade impact. Specifically, when the handle part of the fishing rod is mounted on the upper arm 1, it is possible that the handle part of the fishing rod and the inner end of the upper arm 1 may partially come into contact with the protective cover, or the handle part of the fishing rod and the inner end of the upper arm 1 may not align in a sense that an outer end of the handle part of the fishing rod may protrude outwardly, and therefore when the automatic fishing rod lifter is triggered to reset the fishing rod, the outer end of the handle part of the fishing rod may impact against the protective cover 5 to mechanically displace the protective cover 5. The U-shape indentation 56 can evade the outer end of the handle part of the fishing rod and the outwardly protruding portion thereof, so as to prevent severe impact which in a long run may damage the protective cover 5.

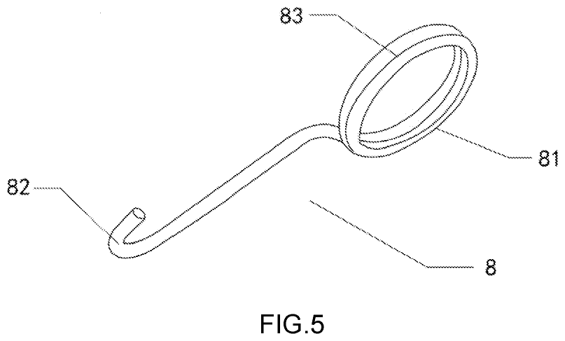

With reference to FIG. 5, due to the great tensional force of the tension springs 6, adjustment and dismounting directly by hands may be effort draining, the therefore, the present invention also comprises a spring adjuster 8 being used together with the automatic fishing rod lifter of the present invention. The spring adjuster 8 comprises a handle 81 and a hook 82; the handle 81 and the hook 82 are bent from a single piece of iron rod so as to form integrally as a single piece of component; the handle 81 is formed as two adjacent loops; a flexible gap 83 exists between the two adjacent loops; the loops of the handle 81 have a size that is suitable to be passed through by a finger to facilitate pulling by user's hand; also, the hook 82 can hook onto a hook of any end of any of the tension springs, so that when pulling the handle 81, the tension springs can be adjusted or dismounted, thereby facilitating effort saving and easy operation. When the spring adjuster 8 is not in use, the spring adjuster 8 may be clamped at the front end of the protective cover 5 or within the recess 53 of the protective cover 5 via the flexible gap 83 of the handle 81 to facilitate storage and portability.

What is claimed is:

1. An automatic fishing rod lifter, comprising an upper arm, a lower arm, and at least one tension spring connecting the upper arm and the lower arm; the upper arm and the lower arm are movably connected so that the upper arm and the lower arm are capable of folding and unfolding with respect to each other; a self-lock trigger mechanism is provided at the upper arm and the lower arm; characterized in that, the automatic fishing rod lifter also comprises a protective cover positioned above the tension spring; one end of the protective cover is movably connected with the lower arm, so that the protective cover is capable of using said one end of the protective cover as a pivot point to flip.

2. The automatic fishing rod lifter of claim 1, wherein the lower arm is provided with a first connecting rod; also, two sides of said one end of the protective cover that allows the protective cover to flip with respective to the lower arm are symmetrically provided with axle holes respectively; the axle holes of the protective cover are engaged by two ends of the first connecting rod respectively; the axle holes are also provided with openings.

3. The automatic fishing rod lifter of claim 1, also comprising a ground mount; one end of the ground mount is movably connected with an inner end of the lower arm, so that the ground mount is foldable; also, an upper side of the protective cover is provided with a recess that corresponds to a shape of the ground mount and into which the ground mount is adapted to be embedded.

4. The automatic fishing rod lifter of claim 3, wherein said one end of the ground mount is provided with position limiting slots; also, the inner end of the lower arm is provided with a second connecting rod; the second connecting rod slides and engages into the position limiting slots.

5. The automatic fishing rod lifter of claim 1, wherein position limiting protrusions are provided at two corresponding opposite positions of two sides of the lower arm respectively; correspondingly, the protective cover is provided at two sides thereof with elongated position limiting holes respectively; the position limiting protrusions are engaged into and slidable within the position limiting holes respectively, so that a flipping magnitude of the protective cover is limited.

6. The automatic fishing rod lifter of claim 1, wherein a front end of the protective cover is also provided with an indentation to evade impact.

7. The automatic fishing rod lifter of claim 1, also comprising a spring adjuster which comprises a handle and a hook connected with the handle; the handle is formed by at least two adjacent loops; a flexible gap exists between the two adjacent loops; the spring adjuster is adapted to be clamped at a front end of the protective cover via the flexible gap.
